(19) United States
(12) Patent Application Publication
(10) Pub. No.: US 2020/0070484 A1
(43) Pub. Date: Mar. 5, 2020

(54) ORIENTED POLYPROPYLENE FILM WITH IMPROVED MACHINABILITY

(71) Applicant: Toray Plastics (America), Inc., North Kingstown, RI (US)

(72) Inventors: Shichen DOU, Coventry, RI (US); Keunsuk P. CHANG, North Kingstown, RI (US)

(73) Assignee: Toray Plastics (America), Inc., North Kingstown, RI (US)

(21) Appl. No.: 16/119,154

(22) Filed: Aug. 31, 2018

(51) Int. Cl. B32B 27/32; B32B 27/18; B32B 27/08; B32B 27/16; B29C 47/00; B29C 47/06

(52) U.S. Cl. CPC B32B 27/32; B29K 2023/12; B32B 27/08; B32B 27/16; B29C 47/0057; B29C 47/065; B32B 2307/7242; B32B 2307/518; B32B 2250/03; B32B 2250/242; B32B 2255/10; B32B 2255/26; B32B 2264/0214; B32B 2264/102; B32B 2439/40; B32B 2307/746; B32B 2307/31; B29C 47/0021; B32B 27/18

(57) ABSTRACT

A multi-layer biaxially oriented polypropylene film (BOPP) can include a core layer; an outer functional layer with the functionalities of heat-sealing, winding, printing, or receiving coatings or metallization; and an outer heat-sealable layer with partially crosslinked polydialkylsiloxane to provide excellent slipperiness and machinability. The partially crosslinked polydialkylsiloxane is not detrimental to the metal adhesion and printability of the functional layer; and maintains excellent heat-seal properties, low and consistent COF, and low and consistent hot slip properties.

### FIELD OF THE INVENTION

This invention is related to a multilayered biaxially oriented polypropylene (BOPP) film with partially crosslinked polydialkylsiloxane slip additive added into the outer heat sealing layer to improve slipperiness and machinability.

### BACKGROUND OF THE INVENTION

BOPP films are commonly used in the multiple converting processes of forming a multilayered packaging structure that needs to be printed, laminated, coated, and sealed under specific process conditions. It should perform multiple functions and have multiple properties, including mechanical and optical properties; the properties provided by a promoting layer suitable for laminating, coating, and/or printing; and the properties of heat sealing and/or accepting cold seal adhesives to form a cold seal adhesive layer for package sealing. In all of those functions and properties, the coefficient of friction (COF) of the outer functional layer's stability under different aging times and environmental conditions and temperatures is crucial to the consistent and reliable machinability of an individual packaging film structure as it is processed in a high speed packaging line. It is also desirable to prevent the cross-contamination of migratory additives that are typically used to improve machinability and controlled COF. A proper film design using a combination of anti-blocking and migratory slip agents can prevent the tendency of blocking and cross-contamination. The combination of the additives of inorganic minerals, crosslinked silicones, organic fatty amides and silicone oils have demonstrated blocking resistance and reduction of the COF of the outer surface layers of a film. Silicone oils or gums are also commonly used as additives in making polyolefin films with improved hot slip COF performance.

Silicone is known as polydialkylsiloxane (most commonly used are polydimethylsiloxane (PDMS)) with a unique chemical structure, a backbone of silicon-oxygen (Si—O) linkages. Polydimethylsiloxane has a low glass transition temperature (Tg=−125° C.) and is commonly used as slip and release agents. Commercially available are silicone fluids (silicone oil and gum types of silicones) with a viscosity of from 0.65 to 2,500,000 cSt; partially cross-linked particles; fully cross-linked particles; and grafted silicone containing polyolefin polymers. Crosslinking of the polymers significantly can increase glass transition temperature. Both non-crosslinked silicone fluids and cross-linked silicones not only can provide good release properties but also reduce the COF of a surface layer. The difference in physical properties (especially shape and hardness) of those crosslinked and partially crosslinked silicones show very different performance characteristics in slip and blocking resistance as they are used in the outer layer of a film. The drawbacks of employing liquid-like silicones include the cross-contamination that can result from the silicone oils transferring to the opposite side of a film as well as giving inconsistent or unstable COF.

U.S. Pat. Nos. 4,734,317 and 6,455,150 described a method of producing a two-side heat-sealable film using silicone oils in the outer layer of the non-treated side. Silicone oil was found to be present on the corona discharge-treated layer side due to direct contact transfer with the non-treated side's surface. The polydiorganosiloxane used in the non-treated outer layer at an amount of 0.5 to 3 wt % was a liquid-like “slip agent”, having a viscosity of 5,000 to 60,000 centistokes (cSt). The effective amount of silicone oil transferred to the treated layer as determined by ESCA was difficult to control due to variations of environments and processing conditions.

U.S. Pat. No. 4,502,263 described a method of making multilayered heat sealable polyolefin film. Polydiorganosiloxane (30,000 cSt) was used to improve the COF and machinability of the heat sealable layer at an amount of 0.3 to 1.5 wt %. The resultant film gave excellent reliability of running in high line-speed packaging machines.

U.S. Pat. No. 5,110,671 described a method of making one-side heat-sealable biaxially oriented polypropylene (BOPP) film using silicone oil with a viscosity of 10,000 to 60,000 cSt to provide an efficient COF-reducing amount for both outer layers. The silicone oil was only added into the heat-sealable layer, which then migrated to the top surface layer of the heat-sealable layer, and was then transferred to the opposite side of the film as it was wound into a roll, forming a silicone coating on the opposite layer's surface and providing COF reduction. The amount of silicone oils transferred to the opposite layer was extremely difficult to control.

U.S. Pat. No. 6,902,822 disclosed a method of making oriented polypropylene film with stable COF using a combination of crosslinked silicone polymer using a slip system of crosslinked silicone and silicone oils at the amount of about 0.1 to 0.5 wt % crosslinked particles and about 0.02 to 0.08 wt % silicone oils. The resultant film had a stable COF and low hot slip COF and could provide good machinability in high-speed packaging machines. Although the viscosity of silicone oils used in the invention was in the range of 300 to 400 cSt, cross-contamination of migrated silicone oils could occur in the film-making process and downstream converting processes, especially in making metallized BOPP films.

U.S. Pat. No. 6,824,878 described a method of producing heat sealable polyolefin film by adding polydialkylsiloxane additive into the intermediate layers between an outer layer and core layer. The intermediate layer comprised about 0.6 to 2.0 wt % of polydialkylsiloxane additive with a viscosity of 1,000 to 50,000,000 cSt. The patent claimed that silicone oils added into the intermediate layers could migrate to the outer layers and then reduce the COF of the outer layers. Corona discharge treatment did not reduce the sealing performance of the film.

US Patent Application US2009/0252902A1 described a method of making printable BOPP film with a slip system of silicone gum (Dow Corning MB50-001) and waxes. Waxes or silicone oils present in the MB50-001 could be detrimental to the printing and lamination function of the film.

EP Patent 1,993,834B1 described a method of making metallized BOPP film with 0.5 to 2.0 wt % polydialkylsiloxane added into the heat-sealable layer using Dow Corning MB50-001. The resultant film had excellent barrier properties and machinability. The polydialkylsiloxane in MB50-001 is a silicone gum, which could have oligomer and low molecular weight silicone oils present in the silicone gum, in which these low molecular weight moieties could transfer to the metal receiving layer. Thus, the metal adhesion could be deteriorated due to the presence of silicone oils. After metallization with aluminum, silicone oils in the sealant layer could transfer to the surface layer of aluminum coating. The metal bond strength to an adhesive applied after downstream lamination could be deteriorated due to the silicone oil present on the metal coating surface contaminating the adhesive's bonding properties.

US Patent Application US2007/0224376A1 described a method of making metallized BOPP film with 0.5 to 2.0 wt % polydialkylsiloxane added into the heat sealable layer using Dow Corning MB50-001. Similar concerns and issues could be developed for the same mechanism for degrading lamination bonds as that addressed to EP Patent 1,993,834B1.

U.S. Pat. No. 6,087,015 described a method of making multilayered matte surface films with a slip system of crosslinked silicone and polydialkylsiloxane at the amount of about 0.1 to 0.5% crosslinked particles and about 0.1 to 1.0 wt % polydialkylsiloxane added into the matte surface layer to improve COF and processability. The polydialkylsiloxane could be from either Dow Corning MB50-001 or MB50-020 masterbatches.

### SUMMARY OF THE INVENTION

None of the practices in the references described above demonstrated or contemplated using a slip system comprising of a partially crosslinked polydialkylsiloxane which has the least potential to result in cross-contamination of silicone oils or low molecular weight silicone moieties to the film-making, metallizing, or other downstream processes and resultant films. In addition, none of the references maintained consistent and reliable COF, hot slip COF, and machinability that are usually provided by silicone oils or gums. In contrast, Applicants have discovered a method to improve the machinability of polyolefin packaging films using partially crosslinked polydialkylsiloxane as a slip and antiblock additive and can avoid using migratory additives in the outer layers and avoid the potential degradation of properties due to migration of low molecular weight moieties.

Disclosed herein are oriented polyolefin films with improved slipperiness and machinability by adding a partially crosslinked polydialkylsiloxane into the outer heat-sealable layer. The partially crosslinked polydialkylsiloxane in the outer heat sealable layer does not impact the coating adhesion, metallizability, and/or printability of the functional layer opposite to the heat-sealable layer.

In some embodiments, a film comprises a core layer of polypropylene homopolymer; a first outer layer which is a functional layer comprising thermoplastic polymers suitable for sealing, adhering, printing or coating; and a second outer layer on the side of the core layer opposite the first outer layer which is a heat sealable and also functions as a slip layer with a controlled coefficient of friction comprising thermoplastic polymers and anti-blocking and/or slip agents. The anti-blocking and/or slip agents in the outer heat sealable layer can include a system of solid spherical particles and partially crosslinked polydialkylsiloxane to improve slipperiness and machinability.

In some embodiments, a polyolefin film comprises a core layer (B); a first outer layer (A) which is a functional layer that could be formulated to have properties of heat sealing, winding, adhesion, coating, metallizing, or printing; a second outer layer (C) which is a slip and heat-sealable layer to provide heat-sealing as well as slipperiness and machinability; one or two (or more) optional intermediate layers (D and/or E) which could be incorporated into the basic film structure to form structures of ADBDC, ABDC, ADBC, ADBEC, AEBDC, etc.; and an optional coating layer or metallized layer (F) which could be added on the top surface of the outer functional layer (A) by either an inline or offline coating process or offline metallizing process. The laminate film can coextruded, cast, and then oriented either uniaxially or biaxially, preferably biaxially oriented in both the machine and transverse directions. The intermediate layers (D and/or E) can be optionally incorporated into the basic film structure depending on the application of the film product chosen by end users.
a. The core layer (B) of the coextruded film can be essentially a layer of polypropylene homopolymer, or high crystalline polypropylene (HCPP) blended with 0 to 25 wt % non-migratory hydrogenated hydrocarbon resins (HCR) as processing aid to improve stiffness and moisture vaopor barrier properties.
b. The outer functional layer (A) can include thermoplastic polymers to provide functionalities of printing, heat sealing, metallizing, coating, and adhesion; and a desirable amount of non-migratory anti-blocking and/or slip agents.
c. The outer layer (C) can essentially comprise thermoplastic polymers and non-migratory anti-blocking and slip agents to provide heat-sealing function and slipperiness.
d. The intermediate layer(s) (D and/or E) can comprise thermoplastic polymers and non-migratory additives to provide effects of adhesion promotion, pigmentation, and sealing improvement or barrier improvement.
e. The coating layer (F) could be added into the basic coextruded film structure through inline coating process after machine direction orientation (MDO), and the coating layer then can be oriented in transverse direction. The coating layer could also be added onto the top surface of the outer layer (A) through offline coating process after the coextruded film is made (for example, a process of metallization by vacuum deposition).

In some embodiments, the films disclosed herein are a heat-sealable polyolefin film. The outer heat-sealable layer (C) can include heat-sealable thermoplastic polymers and non-migratory anti-blocking and slip additives. Examples of suitable thermoplastic polymers for heat-sealability include, but are not limited to, the copolymers and terpolymers of propylene, ethylene, and butene-1 monomers with a melting temperature in the range of from 60 to 150° C. and a melt flow rate of from 5 to 12 g/10 min (2.16 Kg/230° C.). Examples of suitable non-migratory anti-blocking and slip agents include, but are not limited to, spherical anti-blocking particles, such as synthetic SiO2 (e.g. SYLOBLOC® silica), crosslinked silicones (e.g. Tospearl® crosslinked silicone microsphere particles), and partially crosslinked polydialkylsiloxane particles (e.g. EverGlide® MB125-11 Ultra and X116EPC).

In some embodiments, the thermoplastic polymer(s) in the outer heat-sealable layer comprises a blend of conventional heat-sealable thermoplastics as well as homopolymers of polyethylene and polypropylene resins. Adding those semi-crystalline homopolymers in the outer heat-sealable layer can increase the crystallization time of the sealant layer so that hot tack strength of sealant layer can be improved.

In some embodiments, the outer layer (A) comprises a blend of thermoplastic polymers which is heat-sealable at the same sealing temperature as the outer heat-sealable layer (C). The outer layer (A) can be discharge-treated for providing functionalities to that surface such as higher surface energy and wetting tension.

In some embodiments, intermediate layers (D and/or E) of thermoplastic polymers can be incorporated into the film structure between the core layer and each outer layer (A or C) of the coextruded film as special intermediate functional layers. In addition, the coextruded films could have either a four or five layer structure of A/D/B/C, AB/D/C, A/D/B/D/C, A/D/B/E/C, etc. The intermediate layers can be used as the functional structure layer of adding additional barrier structures such as tie-layers, pigmented layers, or a cavitated layers to provide other properties or functionalities.

In some embodiments, the films disclosed herein can be inline coated on the outer layer (A) to add a layer of gas barrier materials or a layer of adhesion primer. The coating layer (F) can be added after machine direction orientation and then oriented in transverse direction in tenter oven. The layer (F) could also be conducted offline after the basic coextruded film is made via offline coating or vacuum deposition.

In some embodiments, the films disclosed herein are offline metallized on the top surface of the outer layer (A). A layer (F) of metals or metal oxides could be deposited on the top surface of the outer layer (A) via vapor deposition within a vacuum chamber. For example, a layer of aluminum metal can be vapor-deposited on the top surface of the outer layer (A) at a thickness of 5 to 100 nanometers (nm). To add transparent barrier coating, a layer of oxides of aluminum or silicon (AlOx or SiOx) or blends thereof can be deposited on the top surface of the outer layer (A) via deposition within a vacuum chamber.

In some embodiments, the core layer (B) of the coextruded film is cavitated or pigmented for providing the aesthetic merit of satisfying the needs of end users such as whiteness or opacity.

In some embodiments, the core layer (B) comprises high crystalline polypropylene (HCPP) and hydrogenated hydrocarbon resin at a desirable amount of from 0 to 25%, preferably, 5 to 15 wt % to improve stiffness and gas barrier properties.

In some embodiments, the core layer (B) of the coextruded heat-sealable film comprises a blend of 85 to 95 wt % crystalline propylene homopolymer and 5 to 15 wt % copolymers and terpolymers of propylene, ethylene, and butene-1 to enhance the heat-seal strength of the film. Additionally, some embodiments could include intermediate layers (D and/or E) that could also be comprised of blends of such homopolymers, copolymers, and/or terpolymers.

In some embodiments, the coextruded laminate film could be a two-layer film comprising a core layer (B) and an outer release layer (C). The outer surface of the core layer opposite to the outer layer (C) can be discharge-treated for functionalities.

In some embodiments, a multilayered polyolefin film includes a core layer comprising crystalline polypropylene homopolymer or high crystalline polypropylene; a first outer layer on a side of the core layer comprising thermoplastic polymers; and a second outer layer on a side of the core layer opposite the first outer layer comprising thermoplastic polymers, 0.1-3 wt. % partially crosslinked polydialkylsiloxane particles, and spherical non-migratory anti-blocking particles, wherein the second outer layer is a heat-sealable layer. In some embodiments, a method of forming a multilayered polyolefin film includes coextruding a laminate comprising: a core layer comprising crystalline polypropylene homopolymer or high crystalline polypropylene; a first outer layer on a side of the core layer comprising thermoplastic polymers; and a second outer layer on a side of the core layer opposite the first outer layer comprising thermoplastic polymers, 0.1-3 wt. % partially crosslinked polydialkylsiloxane particles, and spherical non-migratory anti-blocking particles, wherein the second outer layer is a heat-sealable layer; and biaxially orienting the coextruded laminate.

In some embodiments, the second outer layer comprises 0.4-1.5 wt. % partially crosslinked polydialkylsiloxane. In some embodiments, the second outer layer comprises 0.25-1 wt. % partially crosslinked polydialkylsiloxane. In some embodiments, the core layer comprises 1-25 wt. % of a non-migratory hydrogenated hydrocarbon resin. In some embodiments, the first outer layer comprises antiblocking and/or slip agents. In some embodiments, a surface of the first outer layer is discharge-treated. In some embodiments, the thermoplastic polymers in the second outer layer are selected from the group consisting of copolymers and terpolymers of ethylene, propylene, and butene-1 monomers. In some embodiments, the thermoplastic polymers in the second outer layer are selected from the group consisting of propylene-containing copolymers, propylene-containing terpolymers, and propylene homopolymers. In some embodiments, the spherical non-migratory anti-blocking particles comprise 0.1-0.5 wt. % of the second outer layer. In some embodiments, the spherical non-migratory anti-blocking particles have a nominal size of about 2-4.5 microns. In some embodiments, the spherical non-migratory anti-blocking particles are particles of crosslinked silicone polymers and/or synthetic SiO₂. In some embodiments, the particles of crosslinked silicone polymers and/or synthetic SiO₂ range from 1-10 μm in size. In some embodiments, the particles of crosslinked silicone polymers and/or synthetic SiO₂ range from 2-6 μm in size. In some embodiments, the partially crosslinked polydialkylsiloxane particles are partially crosslinked polydimethylsiloxane (PDMS) particles. In some embodiments, the partially crosslinked PDMS particles range from 0.25-10 μm in size. In some embodiments, the partially crosslinked PDMS particles range from 0.5-6 μm in size. In some embodiments, the thickness of the second outer layer is 0.5-4 μm. In some embodiments, the thickness of the second outer layer is 0.5-2 μm. In some embodiments, the second outer layer has a film-to-platen dynamic coefficient of friction (COF) of 0.15-0.35 at platen temperatures 80° C. or lower. In some embodiments, the film further comprises a polymer coating on a side of the first outer layer opposite the core layer. In some embodiments, the film further comprises a gas barrier layer on a side of the first outer layer opposite the core layer comprising metal, metal oxide, or silicone oxide. In some embodiments, the gas barrier layer has an adhesion force to the first outer layer higher than 120 g/in. In some embodiments, the gas barrier layer has an adhesion force to the first outer layer higher than 150 g/in. In some embodiments, the first outer layer has a wetting tension of 38 dyne-cm or greater. In some embodiments, the first outer layer is a heat-sealable layer. In some embodiments, a surface of the first outer layer is discharge-treated.

Additional advantages of this invention will become readily apparent to those skilled in this art from the following detailed description, wherein only the preferred embodiments of this invention are shown and described, simply by way of illustration of the best mode contemplated for carrying out this invention. As will be realized, this invention is capable of other and different embodiments, and its details are capable of modifications in various obvious respects, all without departing from this invention. Accordingly, the description is to be regarded as illustrative in nature and not as restrictive.

### BRIEF DESCRIPTION OF THE DRAWINGS

FIG. 1 is the schematic structure of partially crosslinked polydialkylsiloxane well-dispersed into the outer layer (C) of a polyolefin film disclosed herein showing particles (˜0.5 to 4 microns) partially or fully exposed to air.

FIG. 2 is the hot slip COF of the example and comparative example films (outer layer (C)) to platen measured at ambient temperature (22° C.) and elevated temperatures up to 80° C.

### DETAILED DESCRIPTION OF THE INVENTION

The coefficient of friction (COF) of the outer layers of oriented polyolefin films (film-to-film or film-to-platen) is crucial for said film to be used successfully in a modern automatic high-speed packaging machine. To make a polyolefin film perform well in a high-speed packaging machine, conventionally, migratory additives such as fatty amides and silicone oils are used to improve its slipperiness and machinability. The effectiveness of the migratory additives used for COF and slip control greatly depends on the amount of the additives that bloom or migrate to the top surface of the outer layer of a film. Generally, the migratory additives on the top surface of the outer layer could be controlled at an amount sufficient to provide excellent machinability but not detrimental to other properties such as required for good printing and lamination. However, applied coatings such as some polymers, metals, or metal oxides can be extremely sensitive to migratory additives on the substrate surface to be coated. Low molecular weight migratory additives on the substrate surface could deteriorate the adhesion between the applied coating layer and the substrate's coating receiving surface and potentially adversely affect, for example, gas barrier properties of gas barrier coatings like vapor-deposited aluminum. Without being bound by any theory, one hypothesis is that these low molecular weight migratory species on the outer layer's surface could vaporize upon contact with the deposition of the aluminum vapor and cause “holes” or breaches in the deposited aluminum metal layer, thus disrupting the continuity and consistency of the aluminum layer and allowing gases to be easily transmitted. Therefore, the properties provided by the coating layer could be significantly affected due to the presence of migratory additives. Migratory additive are undesirable to be used as anti-blocking and slip agents in making coextruded films to be coated upon the outer surface layer A for gas barrier or other functionalities, although they can provide excellent slipperiness and machinability.

Silicone oils which are incompatible with polyolefin migrate to the surface and then form an oily layer that functions as a lubricant. The oily layer present on the surface of a polyolefin film is known to cause potentially sealing and adhering problems due to its incompability to polyolefins. Generally, analytical methods such as Time-of-Flight Secondary Ion Mass Spectrometry (TOF-SIMS) and Electron Spectroscopy for Chemical Analysis (ESCA) are be used to determine the trace amounts of silicone oil contamination and transfer. However, these methods are impractical for quality control during production. Since silicone-based additives reduce the surface energy of an outer surface layer rather drastically, surface energy or wetting tension measurement (using dyne pens or contact angle) could be used to quickly and effectively determine the presence of unwanted silicone oil contamination in production of films.

Polydialkylsiloxane is commonly used as slip and release agents in the packaging film industries. Generally, the viscosity of silicone fluids less than 100,000 cSt is usually called silicone oil; whereas, the viscosity of silicone fluids higher than 100,000 cSt is called silicone gum. Both of them (oil and gum) contain a significant amount of silicone oligomer and small molecules which are highly movable and migratory. Commercially available are the masterbatches of silicone fluids with a viscosity of from 10,000 to 2,500,000 cSt compounded in polyolefin carrier resins at an active loading of 10 to 50 wt %. The masterbatches of silicone fluid are typically added into the outer layers of polyolefin films. Silicone oils (low molecular species) migrate to the top surface of the outer layers forming an oily layer of silicone, especially if the viscosity of silicone fluids is lower than 100,000 cSt. The compounds of silicone gum or ultra-high molecular weight silicone gum generate a lower extent of silicone oil migration, although a significant amount of low molecular weight silicone oil can still be found on the outer surface layers, which could be extremely detrimental to adhesion and lamination.

Fully crosslinked silicone polymers (e.g. Tospearl® silicone polymer particles) are commercially available in the market as excellent anti-blocking and slip agents in film-making. However, those fully crosslinked silicone polymers are solid particles and do not provide the same degree of slipperiness and lubricity of liquid-like silicone polymers. Such fully crosslinked silicone polymers do not migrate to the surface of the film substrate. Instead, they function as an inorganic solid antiblock particle by protruding a portion of the particle above the film substrate's surface.

There is a need to improve the properties of slipperiness and lubrication of the polyolefin films that could not be lubricated by using migratory additives, silicone oils, or silicone gum, and to eliminate unwanted impacts resulting from the migration and transfer of low molecular weight species. A practice has been conducted by partially crosslinking polydialkylsiloxane via reactive extrusion compounding using SiO2-treated functionalized ultra-high molecular weight polydimethylsiloxane, an initiator, and polyolefin polymers, for example, those partially crosslinked polydialkylsiloxane EverGlide® MB-125-11 Ultra and X116EPC provided by Polymer Dynamix LLC, and HMB-6301 provided by Dow Corning. The weight percentage of the active component in these partially crosslinked polydialkylsiloxane masterbatches is about 25 wt % in the carrier resin, comprising either of homo-polypropylene or propylene copolymers.

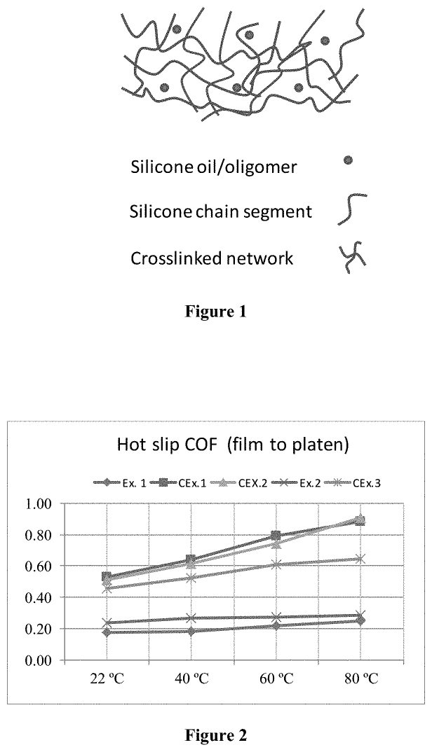

Without being bound by any theory, the schematic structure of partially crosslinked polydialkylsiloxane is herein shown in FIG. 1. As the well-dispersed partially crosslinked polydialkylsiloxane masterbatch materials is added into the outer layers of polyolefin films, some of the partially crosslinked polydialkylsiloxane particles (nominal particle size of about 0.5 to 4 microns) can be partially or fully exposed to air. The size of particles used herein is the nominal particle size unless stated otherwise. Domains (particles) of silicone polymer chains are very surface-active, providing low local surface tension, having a strong tendency to orient themselves on the air/liquid interface. Silicone polymer tails or chain segments as well as the potential lower molecular weight silicone oils can reside inside the partially crosslinked polydialkylsiloxane network/particles, and can be exposed upon the top surface and facilitate lubrication and slip, so the COF of the outer layer of a polyolefin film can be reduced. Inevitably, a trace amount of low molecular weight species (e.g. oligomers) can be still found in the particles of partially cross-linked polydialkylsiloxane. However, these lower molecular weight moieties of silicone oils and oligomers are more likely confined within the partially crosslinked particles due to both the chemical linkage of crosslinking and molecular similarity, giving a lower tendency to form an oily layer of silicone on the top surface of a polyolefin film, especially if the outer layer C is made from high crystalline homopolymer polypropylenes.

A stable physical shape of partially crosslinked polydialkylsiloxane can be maintained for anti-blocking purpose in a long storage period of time, resulting in a stable COF. In addition, at elevated temperatures, the lubricating effectiveness of the silicone tails or segments can increase (i.e. also known as “hot slip”), so the COF of “film-to-platen” and “film-to-film” can be maintained at a lower level, compared to the example of using fully crosslinked silicone polymers (e.g. Tospearl® T120 particles).

The materials on the top surface of an outer layer can include thermoplastic polymers, anti-blocking particles, and slip agents. The effectiveness of the anti-blocking and slip agents can be expected to be maintained over time and at elevated temperatures, such as those exposed to a hot steel platen surface of a COF testing machine (which simulates the surfaces of a packaging machine's forming collar and frictional heating). The surface tension of an outer layer with added partially crosslinked polydialkylsiloxane can be locally very different due to surface tension gradient of different materials.

### Outer Layer (A)

The coextruded outer skin layer (A) which is designed for functionalities could be formulated from polyolefin resins well known in the art for the application of heat-sealing, winding, adhesion, or printing. The polyolefin resins can include ethylene homopolymer, propylene homopolymer, copolymers and terpolymers of ethylene, propylene and/or butene-1 monomers, or blends thereof. Modified polar polyolefin resins, for instance, maleic anhydride-grafted polar polyolefins or copolymerized polar polyolefin resins could be added into the outer layer (A) to promote adhesion, particularly as a tie-resin or tie-layer for receiving polar polymer coatings or coextruded layers (e.g. vinyl alcohol or ethylene vinyl alcohol polymers). The antiblock in the outer layer (A) can selected from particles of synthetic silicates (e.g. Mizusawa Chemical Silton® JC30 grade), synthetic silica SiO₂, fully crosslinked silicone polymers, and/or organic anti-blocking polymers such as PMMA.

Suitable examples of thermoplastic polymers for the outer functional layer (A) can include homopolymers of polypropylene and polyethylene resins such as Total Petrochemical 3571 and Dow DOWLEX® 2027G, respectively; mini-random (i.e. comprising a co-monomer other than propylene at less than 1.0 wt %) polypropylene polymer such as Total Petrochemical LX11203; propylene-ethylene copolymers such as Total Petrochemical 8473, ExxonMobil Vistamaxx® 3588FL, and Basell Adsyl® 7416 XCP; copolymers and terpolymers of ethylene, propylene and butene such as Sumitomo WF345J8; and blends thereof.

Examples of optional anti-blocking and slip agents that can be included into the outer layer (A) include, but are not limited to, spherical anti-blocking particles, such as synthetic SiO2 (e.g. SYLOBLOC® silica), crosslinked silicones (e.g. Tospearl® crosslinked silicone polymer microsphere particles), and partially crosslinked polydialkylsiloxane particles, spherical inorganic silicas, sodium calcium aluminosilicates. Suitable organic anti-blocking agents can include those such as cross-linked silicone polymers (polymethylsilsesquioxane, e.g. Momentive Tospearl® particles) and polymethylmethacrylate (PMMA particles), and partially cross-linked polydialkylsiloxane particles.

### Core Layer (B)

The core layer (B) of the coextruded laminate film can include crystalline propylene homopolymers and/or high crystalline polypropylene homopolymers (HCPP). Examples of suitable homo-polypropylene resins include Total Petrochemical grades 3271 and 3274, Phillipps 66 CH016 and CH020-01. Examples of suitable high crystalline polypropylene resins (HCPP) include Phillips 66 CH020XK, Total Petrochemical 3270 and 3273. Typically, these polypropylene resins can have a melt flow rate in the range of from 1.5 to 4.0 g/10 min., a melting point in the range of from 160-167° C., and a density of about 0.90-0.92 g/cm³. Typically, HCPP resins can have xylene solubles less than 3%.

As HCPP is used as the core layer resin, a desirable amount of hydrogenated hydrocarbon resins can be added into the core layer as a processing aid at an amount of about 1.0 to 25 wt % of the core layer, preferably, about 2.5 to 10 wt % of the core layer. Examples of suitable hydrogenated hydrocarbon resins include Plastolyn® R1140 and Eastotac® H-142W provided by Eastman Chemicals; Oppera® PR100A provided by ExxonMobil. Typically, these hydrocarbon resins can be fully hydrogenated water-white amorphous materials having a softening point of from 130 to 150° C.; a glass transition temperature (Tg) in the range of from 75 to 90° C.; and a weight-average molecular weight (Mw) in the range of from 500 to 1000 g/mole.

### Outer Layer (C)

The outer layer (C) could be designed for the purpose of heat-sealing, receiving of cold seal adhesives, and blocking resistance to adhesives such as cold seal latex rubber-based adhesives or pressure-sensitive adhesives of label stocks. The outer layer (C) can include a blend of thermoplastic polymers, spherical anti-blocking particles, and partially cross-linked polydialkylsiloxane particles. Preferably, the spherical anti-blocking particles can be fully crosslinked silicone polymers and the partially crosslinked polydialkylsiloxane can be partially crosslinked polydimethylsiloxane.

In some embodiments, the films disclosed herein are directed towards heat-sealing applications—though not limited by this embodiment—and suitable heat-sealable resins include but not limited to conventional ethylene-propylene-butylene terpolymer, ethylene-propylene copolymer, propylene-butylene copolymer, propylene homopolymers and ethylene homopolymers, and blends thereof. A suitable ethylene-propylene-butene (EPB) terpolymer can be supplied by Sumitomo grade WF345J8. The heat-sealant compositions can demonstrate a balance between minimum seal initiation temperature and machinability of film processing during the steps of casting, stretching, slitting, metallizing, and packaging. Copolymers with lower melting temperature in the heat-sealable layer tend to stick to the cooling drum because they crystallize at lower temperatures when a film is cast prior to machine direction orientation. Homopolypropylene and copolymers with higher melting temperatures are used to offer the capability of crystallization at higher temperature to avoid sticking issues during casting. The structure and properties of these terpolymers are widely described in the art.

Suitable copolymers with lower melting temperature include propylene-butylene based and ethylene-propylene based copolymers. The propylene-butylene based copolymer can have 20-40 wt % butylene content and can be a metallocene-catalyzed random thermoplastic elastomer. The elastomer can be less crystalline and can have perfect miscibility with polypropylene and ethylene-propylene copolymer resins. Suitable metallocene-catalyzed propylene-butylene copolymers can include those manufactured by Mitsui Chemicals under the tradename Tafmer® and grade names XM7070 and XM7080 having a melting point of 75° C. and 83° C. and a Vicat softening point of 67° C. and 74° C., respectively. The random copolymers can provide lower seal initiation temperature and maintain high seal strength when used as a heat sealant modifier. Suitable ethylene-propylene copolymers can include ExxonMobil's Vistamaxx® 3980 FL and Dow Chemical's Versify® 3200 thermoplastic elastomers. The Vistamaxx 3980FL resin has an ethylene content of 8 wt %, 8 g/10 min of MFR at 230° C., density of 0.88 g/cm³, T_{g} of −22° C., melting temperature 78° C., and Vicat softening point of 80° C. The Versify 3200 resin has about 9 wt % ethylene content, 8 g/10 min of MFR at 230° C., density of 0.876 g/cm³, T_{g} of −23° C., melting temperature 82° C., and Vicat softening point of 59° C. These elastomers can be blended with other higher melting temperature copolymers or terpolymers such as Sumitomo WF345J8 in amounts ranging from 1.0-50.0 wt % of the blend, more preferably, 20-40 wt %.

Intermediate Layer (D and/or E)

Optionally, the films disclosed herein can be incorporated with one or two layers of intermediate layer D or E for the optimization of film structure and functionalities, depending the application and properties required for final products. For example, TiO₂ pigment masterbatch could be added in the intermediate layer to increase whiteness of polyolefin film and CaCO3 masterbatch could be added into the intermediate layers to provide a cavitated structure. Heat-sealable polyolefins could be added into the intermediate layer adjacent to a sealant layer to increase the total thickness of the sealant layer and increase sealing strength.

### Coating Layer (F)

A layer of polymer coatings, metal coating (e.g. Aluminum), or coatings of oxides (e.g. AlOx or SiOx) can be added on the top surface of the outer layer A via inline or offline processes to improve gas barrier properties, for example.

### Anti-Blocking and Slip Agents

Anti-blocking and slip agents can be extremely important to reduce blocking force and COF. Low and stable COF can achieve good machinability of a heat-sealable film. The coextruded outer skin layers (A and C) on both sides of the core layer (B) can have a thickness after biaxial orientation between about 0.1 and 3 μm, preferably between about 0.5 and 2.5 μm, and more preferably between about 0.5 and 2.0 μm. It is well-known to those skilled in the art, that adding inorganic or organic anti-blocking agents into the outer skin layers can improve processability in film-making and handling. A desirable amount of anti-blocking and/or slip agents may be added up to 50,000 ppm to an outer layer, depending on their functionality, preferably about 300-30,000 ppm of anti-blocking and/or slip agents may be added. Suitable inorganic anti-blocking and slip agents for the outer functional layer include those such as spherical inorganic silicas and sodium calcium aluminosilicates. Suitable organic anti-blocking agents include those such as cross-linked silicones (polymethylsilsesquioxane, Tospearl® 120, 130 and 145 particles) and polymethylmethacrylate (PMMA particles), and partially cross-linked polydialkylsiloxane particles. Typically, desirable particle sizes of these anti-blocking agents are in the range of from about 1-12 μm, preferably in the range of from about 2-5 μm.

Applicants discovered that partially crosslinked polydialkylsiloxane particles can be used to improve further slipperiness and machinability, particularly for hot slip properties. They have an irregular particle surface, low surface energy, and non-flowable physical property. The potential silicone oligomer residues inside the partially cross-linked particles are greatly confined within the particles so that the content of mobile and migratory silicone oligomers is not substantially detrimental to the functionalities of the outer functional layer (A) and the performance of the outer layer (C). The partially cross-linked polydialkylsiloxane particles have the slip attributes of silicone oil but not the tendency to transfer to the top surface of the opposite layer as a result of direct contact or migration. Preferably, the particle sizes are controlled in the range of about 0.5 to 10 microns, more preferably in the range of from about 0.5 to 4 microns. The content of partially crosslinked polyalkylsiloxane can be in the range of from about 0.1 to 3 wt % of an outer layer, about 0.25-1 wt. %, or about 0.4 to 1.5 wt %. Partially cross-linked polydialkylsiloxane is usually produced by reactive extrusion compounding processes using silica-treated functionalized silicone gum (ultra-high molecular weight siloxane), initiator, and propylene homopolymer or copolymers. Examples of those partially cross-linked silicone gum include EverGlide® MB-125-11 Ultra and X116EPC masterbatches, provided by Polymer Dynamix. The active composition of polydialkylsiloxane in MB125-11 and X116EPC is about 25 wt % of the masterbatch. The carrier resins used in compounding MB125-11 and X116EPC were homopolypropylene and propylene copolymer, respectively. Other examples of suitable partially crosslinked polydialkylsiloxane also include Dow Corning HMB-630. The active content in HMB-6301 is 25 wt % in homo-polypropylene carrier resin.

In some embodiments, the anti-blocking and slip agents in any outer layer can include crosslinked silicone polymers, synthetic SiO2, and partially crosslinked polydialkylsiloxane particles, and blends thereof, with the content of partially crosslinked polydialkylsiloxane particles in the range of about 0.25 to 1.0 wt % and the total content of the anti-blocking and slip agents in any outer layer not greater than about 2 wt %.

### Processing Aid

An optional but desirable amount of fluoropolymer additive can be included in the outer layers to improve the distribution of additives and help prevent die lip buildup. The content of the fluoropolymer additive can be in the range of about 100-1000 ppm of the outer layer, preferably about 300-600 ppm of the outer layer. These fluoropolymer processing aids are well known in the prior art as a processing aid and are commercially available in a masterbatch form.

### Testing Methods

The various properties in the examples were measured by the following methods:

Wetting tension/surface energy of the surfaces of a polyolefin film was measured substantially in accordance with ASTM D2578-67. In general, the preferred value was equal to or greater than about 36 dyne-cm/cm² to achieve good printability and adhesion of coatings.

Heat seal strength was conducted on the biaxially oriented polyolefin base film using a Sentinel Sealer model 12 ASL, at 0.5 second dwell, 20 psi (137.9 kPa) seal jaw pressure, with upper sealer jaw flat bar design, heated, and TFFLON™ coated, and lower sealer jaw flat bar design, unheated, and rubber with glass cloth covering. The heat-sealed test sample was sealed in the transverse-direction of the film, cut into 1″ (25.4 cm) wide strips, and then placed in an Instron® tensile tester whereupon the peak seal strength (the peak force to separate the sealed films) was measured and recorded. The heat seal strengths of the films disclosed herein can be greater than about 200 g/in, about 300 g/in, about 400 g/in, about 500 g/in, about 600 g/in, about 700 g/in, or about 800 g/in. In some embodiments, the heat seal strengths of the films disclosed herein can be about 200-1000 g/in, about 300-900 g/in, or about 400-800 g/in.

Hot tack strength test was conducted on a Lako Tool hot tack/sealer model SL10 at 30 psi, 0.5 second dwell time, with heated flat lower seal jaw Teflon coated, and unheated upper seal jaw and with delay set to 0 seconds in accordance with ASTM F-1921 method B. The preferred values for acceptable hot tack are about 150 g/in or greater at 250° F. seal temperature.

Printability was rated qualitatively using a ranking system of 1.0-4.0, with 1.0 equating to very poor printability and 4.0 equating to excellent printability. 8½″×11″ cut-sheet samples of the films were coated via hand drawdowns using a #4 Meyer rod on the side of interest with ca. ½ teaspoon ink (CC-ST 62 white ink from Toyo ink), dried at 60° C. for 60 seconds in an oven, and tested for ink adhesion using a tape test. A strip of 24 mm wide adhesive cellophane tape is adhered to the non-inked side; a strip of 12 mm wide adhesive cellophane tape (e.g. 3M 610 tape) is adhered to the inked side corresponding to the area covered by the 24 mm tape on the un-inked side, and peeled off quickly, keeping the hand parallel to the film sample. The amount of ink remaining on the peeled surface of the film sample is then rated as follows:

1.0=75% ink removed

2.0=50% ink removed

3.0-25% ink removed

4.0=0-10% ink removed

In general, preferred value for printability is 3.0 or above.

Metal adhesion was measured by sealing Primacor® (25 μm thick FAA film) on a Sentinel Sealer model 12 ASL to a metal-coated surface of a metallized film at the conditions of temperature 1.04.4° C., dwell time 15 seconds, and jaw pressure 15 PSI; and then measured using Instron® tensile tester at the 180° angle, the peel strength of the metal coating layer from the substrate (outer layer A) is recorded in accordance with AIMCAL (Association of Industrial Metallizers, Coaters, and Laminators) test procedure TP-105-92. The metal adhesion of the films disclosed herein can be greater than about 50 g/in or 100 g/in.

Lamination bond was measured using Instron® Tensile Tester at the 180° peel angle to separate the low density polyetheylene (LDPE) adhesive layer and the aluminum metal coating layer of a laminated metallized film. A typical test lamination had a structure of: 70G clear OPP//60G LDPE adhesive//70G Al-metallized OPP film. The lamination bond strength of the films disclosed herein can be greater than about 25 g/in, about 50 g/in, or about 100 g/in. In some embodiments, the lamination bond strength of the films disclosed herein can be about 25-125 g/in or about 50-100 g/in.

Coefficient of friction (COF) was measured according to ASTM D-1894 using a Testing Machine, Inc. (TMI) model 32-06 Monitor/Slip & Friction tester. Hot slip COF (film-to-platen) was measured to determine the slipperiness and machinability of a film at a temperature range of from ambient (22° C.) to 40, 60, and 80° C. The film's surface of interest (typically layer C) was tested either in contact with another sheet's layer C; or with layer C in contact with the COF tester's platen. Preferred values for static and dynamic COF are less than about 1.00 for film-to-film and less than about 0.40 for film-to-platen.

Oxygen transmission rate is measured using Mocon Ox-Tran® Model 2/21 according to ASTM D-3985. The oxygen transmission rate of the films disclosed herein can be less than about 4 cc/100 in2/day at 70° F. and 0% RH or less than about 1.5 cc/100 in2/day at 70° F. and 0% RH.

Moisture transmission rate is measured using Mocon Permatran-W® Model 3/31 according to ASTM D1249. The moisture transmission rate of the films disclosed herein can be less than about 0.03 g/100 in2/day at 100° F. and 90% RH or less than or equal to about 0.01 g/100 in2/day at 100° F. and 90% RH.

### Film Making Process

For a typical 3-layer coextruded film as described previously, the coextrusion process can include a three-layered compositing die. The polymeric core layer (B) can be sandwiched between the outer layer (A) and the outer heat-sealable layer (C). The outer layer (A) of the three-layer laminate sheet can be cast onto a chilling or casting drum with a controlled temperature in the range of from about 15 to 45° C. to solidify the non-oriented laminate sheet, followed by a secondary cooling on another chilling drum with a controlled temperature. The non-oriented laminate sheet can be stretched in the machine direction at about 95 to 165° C. at a ratio of about 4 to 6 times of the original length and then heat set at about 50 to 100° C. to obtain a uniaxially oriented laminate sheet with minimal thermal shrinkage. The uniaxially oriented laminate sheet can be introduced into a tenter and preliminarily heated between about 130° C. and 180° C., and stretched in the transverse direction at a ratio of about 7 to 10 times of the original length and then heat-set to give a biaxially oriented sheet with minimal thermal shrinkage.

Surface treatment discussed above may be applied to either layer A or layer C before rewinding the film, depending on the film product design; but preferably layer A.

The total thickness of the coextruded polyolefin film could be in the range of from about 10 to 50 microns, preferably about 12 to 30 microns, and more preferably about 15 to 25 microns. The thickness of the outermost layers (A and C) can be in the range of from about 0.25 to 4 microns, preferably about 1.0 to 2.0 microns.

The coextruded oriented film can then be used for offline metallization. Gas barrier properties and metal adhesion can be tested as quality control requirements. The metallized barrier film could be laminated with a second printed film using solvent-based adhesives or extrusion-laminated with LDPE adhesives according to the skills known in the art. The printed film could be either a printed BOPP or polyester film made in reverse printing process. The lamination adhesives can be inserted between the metal coating and ink surface of the respective films for the lamination. After lamination, the adhesion between adhesive and metal coating can be evaluated to assure a required bond strength which is higher than about 20 g/in, preferably about 50-100 g/in, and more preferably, greater than about 100 g/in.

The present invention can be better understood with references to the following examples, which are intended to illustrate specific embodiments within the overall scope of the invention.

### EXAMPLES

Table 1 demonstrates the attempted film structure and recipes of Examples (Ex.) and Comparative Examples (CEx.) in the present invention. Partially crosslinked polydialkylsiloxane (labeled as “PX-Silicone” in Table 1) is added into the outer heat-sealable layer C at different loading levels to improve the slipperiness and machinability. Tospearl™ fully crosslinked silicone polymer particles and partially crosslinked polydialkylsiloxane are pre-compounded into masterbatch resins using carrier resin EP copolymer Vistamaxx® 3588FL. The coextruded laminate film was made on a 8-meter wide BOPP tenter-frame film-making line with a line speed up to 1400 feet/min. All tri-layer coextruded films are made under the same processing conditions by coextrusion, casting, orientation, and annealing. There were no changes in the recipes of the core layer B and metal receiving layer A. After a base film is made by this process, the film is slit and then metalized by vacuum deposition of aluminum. After metallization, metallized films were laminated with a printed BOPP film using LDPE adhesives by extrusion lamination process. The basic process of making the films are shown in Table 1. Any changes made to each individual example will be addressed by the description of each respective example below.

### Example 1

Example 1 was made on an 8-meter wide BOPP film line at a line speed of 1400 ft/min. using processing conditions described previously. The outer layer A of Ex.1 comprised about 100 wt % Total LX11203, which is a mini-random polypropylene resin with 0.6 mol % ethylene and compounded with 300 ppm Silton® JC30 silicate anti-blocking particles. The skin thickness of the outer layer A is about 3.0 gauge (G) or 0.03 mil or 0.75 μm. The core layer B (59G or ca. 14.75 μm) of Ex.1 comprised about 100 wt % Phillips 66 CH020XK HCPP resin. The outer layer C of Ex. 1 comprised a blend of about 30 wt % Sumitomo WF345 terpolymer of ethylene, propylene and butene-1 monomers, 59.0 wt % ExxonMobil Vistamaxx™ 3588FL, 10 wt % Mitsui Chemical Tafmer™ XM7070 copolymer, 0.25 wt % Tospearl™ 120 particles (nominal 2.0 μm diameter) and 0.75 wt % partially crosslinked polydialkylsiloxane (PX-Silicone). The thickness of the outer layer C is about 8G or 2.0 μm. The total thickness of the coextuded film is about 70G or 17.5 μm measured after the film is wound at the winder. After the coextruded film had aged more than 12 hours at ambient conditions, properties of COF, wetting tension, printability, and heat-seal strength was determined using ASTM methods or internal QC test methods described in the section “Test Methods”. The coextruded film was slit into smaller rolls with a desirable width and roll diameter suitable for offline metallization. Aluminum metal deposition coating process was conducted in a vacuum chamber and the optical density (OD) of the aluminum coating was set at 3.2. The properties of metal adhesion and gas barrier were determined using methods described in the “Test Methods” section. The metallized film was then laminated with a printed BOPP film 70G F62W (commercially available product made by Toray Plastics (America), Inc.) using Marlex® 1017 LPDE adhesive at extrusion temperature of about 315° C. and lamination speed 400 ft/min. The Marlex® 1017 LPDE adhesive—provided by Chevron Phillips Chemical Company—had a melt flow rate of 7 g/10 min. (2.16 Kg/190° C.), a density of 0.92 g/cm³, and a melting temperature of 104° C. After lamination and 12 hours aging at ambient conditions, the laminated film sample was separated to determine the lamination bond strength between aluminum metal coating and LDPE adhesive.

### Comparative Examples 1 and 2

The film sample CEx.1 was made using the same conditions and methods as that of Ex.1. The anti-blocking and slip agents in the outer heat-sealable layer C was changed to be 0.25 wt % Tospearl™ 120 particles and 0.25 wt % Tospearl™ 130 particles (nominal 3.0 μm diameter). No partially crosslinked polydialkylsiloxane was added into the outer layer C. No change was made to the recipes and thickness of the core layer B and the metal receiving layer A. The recipe of CEx.1 is shown in Table 1.

The film sample CEx.2 was made using the same conditions and methods as that of Ex.1 The anti-blocking and slip agents in the outer heat-sealable layer C was changed to be 0.25 wt % Tospearl™ 120 particles and 0.25 wt % Tospearl™ 145 particles (nominal 4.5 μm diameter). No partially crosslinked polydialkylsiloxane was added in the sealant composition.

The film samples made in CEx. 1 and 2 were slit and then metallized using the same conditions and methods as that of Ex.1. After metallization, the metallized film samples are subslit and then laminated with 70G F62W print film using LDPE adhesive as that of Ex. 1.

Table 1 showed that the film-to-film dynamic COF of the outer layer C of the film sample in Ex.1 was much lower than that of the film samples in CEx.1 and 2. In addition, FIG. 2 showed that the outer layer C of the film sample in Ex.1 had a stable low hot slip dynamic COF. The hot slip COF only increased slightly from about 0.18 to 0.25 as the temperature was increased from 22° C. to 80° C. The hot slip COF of the outer layer C of two comparative films made in CEx. 1 and 2 was as high as about 0.52 at ambient condition and increased to about 0.9 at hot platen environment 80° C. In Comparative Example 2, larger anti-blocking particles Tospearl™ 145 (nominal 4.5 μm diameter) was used to replace Tospearl™ 130 (nominal 3 μm diameter) in an attempt to reduce the film-to-platen and hot slip COF of the outer layer C; it was found that the addition of the larger size Tospearl™ 145 did not usefully change the slipperiness and machinability of the outer layer C. In comparison, 0.75 wt % of partially crosslinked polydialkylsiloxane in the outer layer C of Ex. 1 significantly reduced the film-to-platen COF as well as hot slip COF; the slipperiness and machinability of the outer layer C was significantly improved.

The outer layer C of the film samples made in Ex. 1 and CEx. 1 and 2 was measured for heat seal strength and hot tack strength temperature at 99° C. (210° F.) and 121° C. (250° F.), respectively. The results presented in Table 1 show that partially crosslinked polydialkylsiloxane in the outer layer C did not impact the performance of heat seal strength and hot tack strength at typical sealing temperatures and conditions required by the packaging industry.

As shown in Table 1, the wetting tension and printability of the outer layer C with partially crosslinked polydialkylsiloxane particles were comparable to that of the film samples made in CEx. 1 and 2. There were no apparent detrimental effects of using the partially crosslinked polydialkylsiloxane—no apparent migration or transfer of low molecular weight silicone-containing moieties was significant enough to affect these properties.

As shown in Table 1, the oxygen gas and moisture vapor barrier properties of the film sample made in Ex. 1 after metallization were comparable to that of the film samples made in CEx. 1 and 2. The partially crosslinked polydialkylsiloxane particles did not adversely impact the barrier properties. The metal adhesion of the metallized film of Ex. 1 was also very good. Excellent lamination bond strength was seen for the metallized film of Ex. 1 (although it was slightly lower than that of the comparative film samples, it was not deemed to be a significant difference for this property).

### Example 2

The film sample of Ex.2 was made using the same conditions and methods as that of Ex.1, while the thickness of the outer layer C was changed to ca.5G (1.25 μm). The anti-blocking and slip agents in the outer heat-sealable layer C were changed to be about 0.25 wt % Tospearl™ 120 particles and about 0.5 wt % partially crosslinked polydialkylsiloxane (PX-Silicone). No change was made to the recipe and thickness of the outer metal receiving layer A. The recipes of Ex. 2 are shown in Table 1.

### Comparative Example 3

The film sample CEx. 3 was made using the same conditions and methods as that of Ex. 2. The anti-blocking and slip agents in the outer heat-sealable layer were changed to be about 0.35 wt % Tospearl™ 120 only. No change was made to the recipes and thickness of the core layer B and the outer metal receiving layer A. The recipes of CEx. 3 are shown in Table 1.

The film samples of Ex. 2 and CEx. 3 were tested for basic film properties and then metallized to 3.2 OD in a vacuum chamber for evaluation on gas barrier properties and metal adhesion. No lamination structure was made using the metallized film samples of Ex. 2 and CEx. 3.

Table 1 showed that the dynamic COF (film-to-film) of the outer heat-sealable layer C of Ex. 2 and CEx. 3 were about the same at the range of 0.40 to 0.41. However, the hot slip COF (film-to-platen) of Ex.2 and CEx. 3 were very different. As the platen temperature was increased from ambient to 80° C., the outer layer C of the coextruded film in Ex. 2 demonstrated relatively stable hot slip dynamic COF performance of about 0.24 at ambient temperature (22° C.) and about 0.29 at elevated temperature 80° C. In comparison, the outer layer C of the coextruded film made in CEx. 3 not only has an initial higher hot slip dynamic COF of 0.46 at ambient temperature (22° C.) but also the hot slip dynamic COF increased significantly to about 0.65 at elevated temperature 80° C. The coextruded film made in Ex. 2 demonstrated better slipperiness and machinability due to its much lower hot slip COF, compared to the film sample made in CEx. 3.

According to the test results presented in Table 2, it was noted that the unmetallized base film and metallized film properties measured in terms of heat seal strength, hot tack strength, wetting tension, printability, oxygen and moisture gas barrier, and metal adhesion were surprisingly not adversely impacted by the presence or use of partially crosslinked polydialkylsiloxane particles added into the outer heat-sealable layer of the coextruded films. Both film samples in Ex.2 and CEx. 3 show lower heat seal strength and hot tack strength at the indicated temperature compared to the film samples made in Ex. 1 and CEx. 2 and 3, but this is likely due to a thinner sealant thickness rather than the presence or absence of partially crosslinked polydialkylsiloxane.

TABLE 1

| | Film structure and compositions | | | |
|---|---|---|---|---|
| | (weight percentage) | | | Layer C |
| | Outer | Core | | thickness |
| Examples | layer A | layer B | Outer layer C | (G) |
| Ex. 1 | LX11203 | CH020XK | 30% WF345 | 8 |
| | | | 59.0% Vistamaxx3588FL | |
| | | | 10% Tafmmer XM7070 | |
| | | | 0.25% Tospearl 120 | |
| | | | 0.75% PX-Silicone | |
| CEx. 1 | LX11203 | CH020XK | 30% WF345 | 8 |
| | | | 59.5% Vistamaxx3588FL | |
| | | | 10% Tafmmer XM7070 | |
| | | | 0.25% Tospearl 120 | |
| | | | 0.25% Tospearl 130 | |
| CEx. 2 | LX11203 | CH020XK | 30% WF345 | 8 |
| | | | 59.5% Vistamaxx3588FL | |
| | | | 10% Tafmmer XM7070 | |
| | | | 0.25% Tospearl 120 | |
| | | | 0.25% Tospearl 145 | |
| Ex. 2 | LX11203 | CH020XK | 30.25% WF345 | 5 |
| | | | 59.0% Vistamaxx3588FL | |
| | | | 10% Tafmmer XM7070 | |
| | | | 0.25% Tospearl 120 | |
| | | | 0.5% PX-Silicone | |
| CEx. 3 | LX11203 | CH020XK | 30.65% WF345 | 5 |
| | | | 59.0% Vistamaxx3588FL | |
| | | | 10% Tafmmer XM7070 | |
| | | | 0.35% Tospearl 120 | |

TABLE 2

| | COF, | Heat seal | | Hot tack | | Wetting | | O2TR | MVTR | Metal | Lamination |
|---|---|---|---|---|---|---|---|---|---|---|---|
| | μd | (g/in) | | (g/in) | | tension | | cc/100 | g/100 | adhesion | bond |
| Example | 22° C. | 99° C. | 121° C. | 99° C. | 121° C. | dyne/cm | Print. | in²/day | in²/day | g/in | g/in |
| Ex. 1 | 0.27 | 311 | 400 | 168 | 246 | 39 | 4 | 0.69 | 0.002 | 192 | 152 |
| CEx. 1 | 0.62 | 322 | 419 | 166 | 206 | 41 | 4 | 1.21 | 0.075 | 188 | 174 |
| CEx. 2 | 0.48 | 328 | 460 | 182 | 254 | 40 | 4 | 0.70 | 0.099 | 180 | 212 |
| Ex. 2 | 0.41 | 251 | 344 | 66 | 193 | 40 | 4 | 0.69 | 0.053 | 176 | NA |
| CEx. 3 | 0.40 | 229 | 364 | 59 | 161 | 40 | 4 | 1.15 | 0.087 | 160 | NA |

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, the amount of antiblocking agent in the outer layer can be less than about 5 wt. %, about 2 wt. %, or about 1 wt. % is meant to mean that the amount of antiblocking agent in the outer layer can be less than about 5 wt. %, less than about 2 wt. %, or less than about 1 wt. %.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

What is claimed is:

1. A multilayered polyolefin film comprising:
a core layer comprising crystalline polypropylene homopolymer or high crystalline polypropylene;
a first outer layer on a side of the core layer comprising thermoplastic polymers; and
a second outer layer on a side of the core layer opposite the first outer layer comprising thermoplastic polymers, 0.1-3 wt. % partially crosslinked polydialkylsiloxane particles, and spherical non-migratory anti-blocking particles, wherein the second outer layer is a heat-sealable layer.

2. The multilayered polyolefin film of claim 1, wherein the second outer layer comprises 0.4-1.5 wt. % partially crosslinked polydialkylsiloxane.

3. The multilayered polyolefin film of claim 1, wherein the second outer layer comprises 0.25-1 wt. % partially crosslinked polydialkylsiloxane.

4. The multilayered polyolefin film of claim 1, wherein the core layer comprises 1-25 wt. % of a non-migratory hydrogenated hydrocarbon resin.

5. The multilayered polyolefin film of claim 1, wherein the first outer layer comprises antiblocking and/or slip agents.

6. The multilayered polyolefin film of claim 1, wherein a surface of the first outer layer is discharge-treated.

7. The multilayered polyolefin film of claim 1, wherein the thermoplastic polymers in the second outer layer are selected from the group consisting of copolymers and terpolymers of ethylene, propylene, and butene-1 monomers.

8. The multilayered polyolefin film of claim 1, wherein the thermoplastic polymers in the second outer layer are selected from the group consisting of propylene-containing copolymers, propylene-containing terpolymers, and propylene homopolymers.

9. The multilayered polyolefin film of claim 1, wherein the spherical non-migratory anti-blocking particles comprise 0.1-0.5 wt. % of the second outer layer.

10. The multilayered polyolefin film of claim 1, wherein the spherical non-migratory anti-blocking particles are particles of crosslinked silicone polymers and/or synthetic SiO₂.

11. The multilayered polyolefin film of claim 10, wherein the particles of crosslinked silicone polymers and/or synthetic SiO₂ range from 1-10 μm in size.

12. The multilayered polyolefin film of claim 11, wherein the particles of crosslinked silicone polymers and/or synthetic SiO₂ range from 2-6 μm in size.

13. The multilayered polyolefin film of claim 1, wherein the partially crosslinked polydialkylsiloxane particles are partially crosslinked polydimethylsiloxane (PDMS) particles.

14. The multilayered polyolefin film of claim 13, wherein the partially crosslinked PDMS particles range from 0.25-10 μm in size.

15. The multilayered polyolefin film of claim 14, wherein the partially crosslinked PDMS particles range from 0.5-6 μm in size.

16. The multilayered polyolefin film of claim 1, wherein the thickness of the second outer layer is 0.5-4 μm.

17. The multilayered polyolefin film of claim 16, wherein the thickness of the second outer layer is 0.5-2 μm.

18. The multilayered polyolefin film of claim 1, wherein the second outer layer has a film-to-platen dynamic coefficient of friction (COF) of 0.15-0.35 at platen temperatures 80° C. or lower.

19. The multilayered polyolefin film of claim 1, further comprising a polymer coating on a side of the first outer layer opposite the core layer.

20. The multilayered polyolefin film of claim 1, further comprising a gas barrier layer on a side of the first outer layer opposite the core layer comprising metal, metal oxide, or silicone oxide.

21. The multilayered polyolefin film of claim 20, wherein the gas barrier layer has an adhesion force to the first outer layer higher than 120 g/in.

22. The multilayered polyolefin film of claim 21, wherein the gas barrier layer has an adhesion force to the first outer layer higher than 150 g/in.

23. The multilayered polyolefin film of claim 1, wherein the first outer layer has a wetting tension of 38 dyne-cm or greater.

24. The multilayered polyolefin film of claim 1, wherein the first outer layer is a heat-sealable layer.

25. The multilayered polyolefin film of claim 24, wherein a surface of the first outer layer is discharge-treated.

26. A method of forming a multilayered polyolefin film, the method comprising:
coextruding a laminate comprising:
a core layer comprising crystalline polypropylene homopolymer or high crystalline polypropylene;
a first outer layer on a side of the core layer comprising thermoplastic polymers; and
a second outer layer on a side of the core layer opposite the first outer layer comprising thermoplastic polymers, 0.1-3 wt. % partially crosslinked polydialkylsiloxane particles, and spherical non-migratory anti-blocking particles, wherein the second outer layer is a heat-sealable layer; and
biaxially orienting the coextruded laminate.

27. The method of claim 26, further comprising discharge-treating a side of the second outer layer opposite the core layer.

28. The method of claim 26, further comprising discharge-treating a side of the first outer layer opposite the core layer.

29. The method of claim 26, wherein the second outer layer comprises 0.4-1.5 wt. % partially crosslinked polydialkylsiloxane.

30. The method of claim 26, wherein the second outer layer comprises 0.25-1 wt. % partially crosslinked polydialkylsiloxane.

31. The method of claim 26, wherein the core layer comprises 1-25 wt. % of a non-migratory hydrogenated hydrocarbon resin.

32. The method of claim 26, wherein the first outer layer comprises antiblocking and/or slip agents.

33. The method of claim 26, wherein the thermoplastic polymers in the second outer layer are selected from the group consisting of copolymers and terpolymers of ethylene, propylene, and butene-1 monomers.

34. The method of claim 26, wherein the thermoplastic polymers in the second outer layer are selected from the group consisting of propylene-containing copolymers, propylene-containing terpolymers, and propylene homopolymers.

35. The method of claim 26, wherein the spherical non-migratory anti-blocking particles comprise 0.1-0.5 wt. % of the second outer layer.

36. The method of claim 26, wherein the spherical non-migratory anti-blocking particles are particles of crosslinked silicone polymers and/or synthetic SiO₂.

37. The method of claim 36, wherein the particles of crosslinked silicone polymers and/or synthetic SiO₂ range from 1-10 μm in size.

38. The method of claim 37, wherein the particles of crosslinked silicone polymers and/or synthetic SiO₂ range from 2-6 μm in size.

39. The method of claim 26, wherein the partially crosslinked polydialkylsiloxane particles are partially crosslinked polydimethylsiloxane (PDMS) particles.

40. The method of claim 39, wherein the partially crosslinked PDMS particles range from 0.25-10 μm in size.

41. The method of claim 40, wherein the partially crosslinked PDMS particles range from 0.5-6 μm in size.

42. The method of claim 26, wherein the thickness of the second outer layer is 0.5-4 μm.

43. The method of claim 42, wherein the thickness of the second outer layer is 0.5-2 μm.

44. The method of claim 26, wherein the second outer layer has a film-to-platen dynamic coefficient of friction (COF) of 0.15-0.35 at platen temperatures 80° C. or lower.

45. The method of claim 26, further comprising coating a polymer on a side of the first outer layer opposite the core layer.

46. The method of claim 26, coating a side of the first outer layer opposite the core layer with a gas barrier layer comprising metal, metal oxide, or silicone oxide.

47. The method of claim 46, wherein the gas barrier layer has an adhesion force to the first outer layer higher than 120 g/in.

48. The method of claim 47, wherein the gas barrier layer has an adhesion force to the first outer layer higher than 150 g/in.

49. The method of claim 27, wherein the first outer layer has a wetting tension of 38 dyne-cm or greater.

50. The method of claim 26, wherein the first outer layer is a heat-sealable layer.
